(19) United States
(12) Patent Application Publication
(10) Pub. No.: US 2010/0165212 A1
(43) Pub. Date: Jul. 1, 2010

(54) Signal source selection techniques

(76) Inventors: Nick Cowley, Wiltshire (GB); Peter Coe, Wiltshire (GB)

Correspondence Address: INTEL CORPORATION;c/o CPA Global, P.O. BOX 52050, MINNEAPOLIS, MN, 55402, US

(21) Appl. No.: 12/317,870

(22) Filed: Dec. 29, 2008

(51) Int. Cl. H04N 5/50; H04B 1/18

(52) U.S. Cl. 348/731; 455/150.1; 348/E05.097

(57) ABSTRACT

Techniques for the selection of signals from multiple sources are disclosed. For instance, an apparatus may include a first tuner module, a second tuner module, and a multiplexer. The first tuner module generates a first tuned signal from a first RF signal, and the second tuner module generates a second tuned signal from a second RF signal. The first RF signal corresponds to a first signal source, and the second RF signal corresponds to a second signal source. Based on a selection signal, the multiplexer selects one of the first tuned signal and the second tuned signal.

### BACKGROUND

Commercial television receivers, such as receivers that access both cable and terrestrial broadcast signal sources in a common tuner, need to establish isolation between such multiple signal sources. For example, receivers are typically required to maintain a radio frequency (RF) isolation between signal sources that is greater than 70 decibels (dB).

Conventional approaches achieve isolation through the deployment of an RF relay that precedes tuning components. However, such RF relays are expensive. In addition, the employment of RF relays present RF layout challenges to achieve acceptable performance.

Further, RF relays are physically large components. This can be problematic for small form factor implementations, such as those needed in flat screen applications, notebook computers, and similar devices.

Moreover, the employment of RF relays entails multiple signal sources sharing a common electrical cavity (i.e., the RF relay). This, in turn, compounds difficulties in achieving desired levels of isolation.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an apparatus that employs an RF relay-based signal selection approach;

FIG. 2 is a diagram of an exemplary apparatus that employs a tuned signal selection approach;

FIG. 3 is a diagram of an exemplary system; and

FIG. 4 is a diagram of an exemplary logic flow.

### DETAILED DESCRIPTION

Embodiments provide techniques for the selection of signals from multiple sources. For instance, an apparatus may include a first tuner module, a second tuner module, and a multiplexer. The first tuner module generates a first tuned signal from a first RF signal, and the second tuner module generates a second tuned signal from a second RF signal. The first RF signal corresponds to a first signal source, and the second RF signal corresponds to a second signal source. Based on a selection signal, the multiplexer selects one of the first tuned signal and the second tuned signal.

Through the employment of such arrangements, drawbacks associated with RF relays may be avoided.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

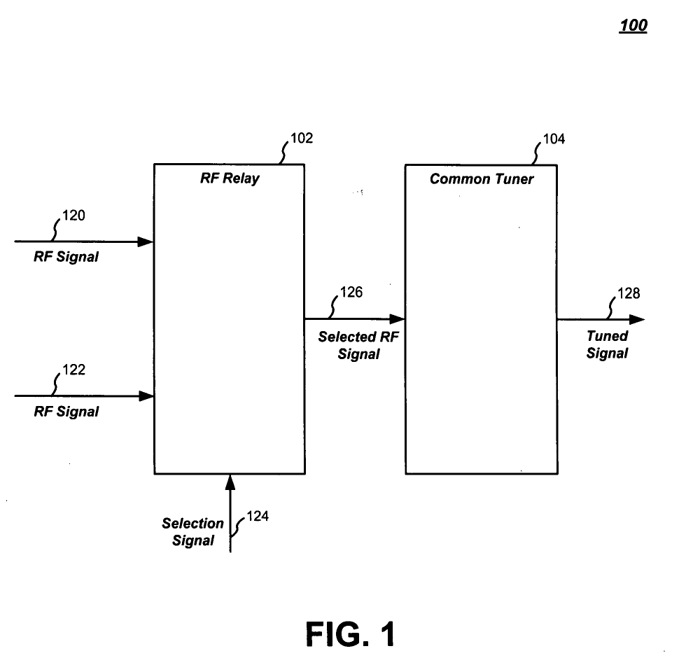

FIG. 1 is a diagram of an apparatus 100 that employs a conventional relay-based signal selection approach. As shown in FIG. 1, apparatus 100 includes a RF relay 102 and a tuner module 104.

RF relay 102 receives an RF signal 120 from a first signal source (not shown), and an RF signal 122 from a second signal source (not shown). Based on a selection signal 124, RF relay 102 forwards one of these RF signals to tuner module 104 as a selected RF signal 126. From this signal, tuner module 104 generates a tuned signal 128 at a lower frequency.

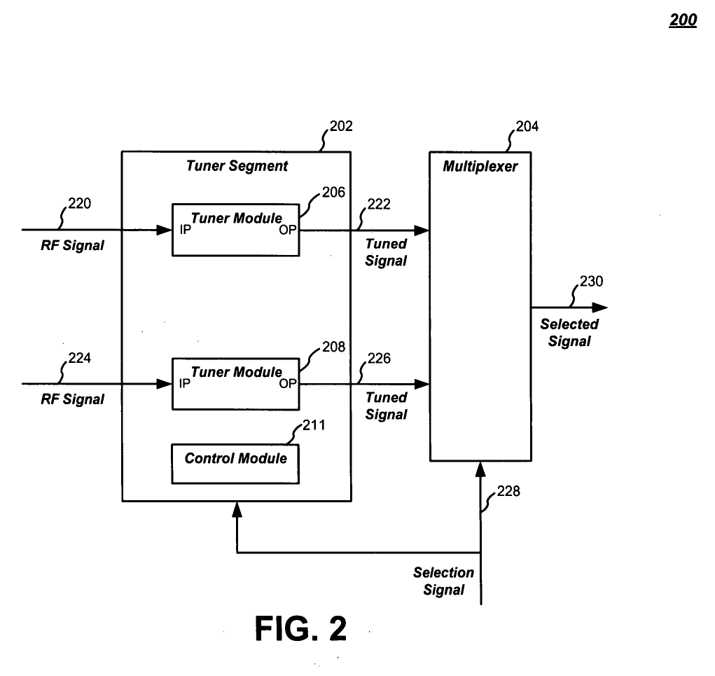

As discussed above, several disadvantages are typically associated with RF relays. For example, RF relays may be expensive, large, and/or challenging to layout. Accordingly, embodiments may avoid such disadvantages through the employment of a tuned signal selection approach. An example of this approach is provided in FIG. 2.

More particularly, FIG. 2 is a diagram of an apparatus 200 that may include various elements. For instance, FIG. 2 shows apparatus 200 including a tuner segment 202 and a multiplexer 204. These elements may be implemented in hardware, software, or any combination thereof.

Tuner segment 202 may include multiple tuner modules. For instance, FIG. 2 shows tuner segment 202 including two tuner modules: a first tuner module 206, and a second tuner module 208. Although two tuner modules are shown, embodiments may employ any number of tuner modules.

Each tuner module may be associated with a particular signal source. For example, tuner module 206 is associated with a first wireless (e.g., terrestrial broadcast) signal source, and tuner module 208 is associated with a second wireless (e.g., cable) signal source. These sources are provided for purposes of illustration, and not limitation. Thus, other combinations of wireless and/or wired signal sources may be employed.

In general operation each of tuner modules 206 and 208 receives an RF signal at an input port (IP). These RF signals may correspond to television broadcasts, such as broadcasts in accordance with one or more digital video broadcast (DVB) standards. Embodiments, however,are not limited to these signal types.

In turn, each of tuner modules 206 and 208 converts its received RF signal into a tuned signal at a lower frequency range. This tuned signal is provided at an output port (OP). For instance, tuner module 206 receives an input RF signal 220 and generates a corresponding tuned signal 222. Similarly, tuner module 208 receives an input RF signal 224 and generates a corresponding tuned signal 226. Tuned signals 222 and 226 may be intermediate frequency (IF), a zero IF (ZIF) or a near zero IF (NZIF) signals. Embodiments, however, are not limited to these exemplary frequencies.

In embodiments, RF input signals 220 and 224 may each be analog signals, while tuned signals 222 and 226 may be digital signals. In such arrangements, each of tuner modules 206 and 208 may include analog to digital converters (ADC). Alternatively, tuned signals 222 and 226 may be analog signals.

As shown in FIG. 2, multiplexer 204 receives tuned signals 222 and 226. Based on a selection signal 228, multiplexer 204 provides one of these tuned signals as a selected signal 230. Selection signal 228 may be generated by a user.

In embodiments, tuner module(s) corresponding to the non-selected tuned signal(s) may be powered down (or have the operational power delivered to such tuner module(s) be reduced). Accordingly, FIG. 2 shows selection signal 228 being forwarded. Based on this signal, control module 211 within tuner segment 204 may perform such powering down or power reductions. Control module 211 may be implemented with hardware, software, or any combination thereof. For example, in embodiments, control module 211 comprises digital logic circuitry.

Multiplexer 204 may be implemented in various ways. In an exemplary implementation, multiplexer 204 may comprise a wired OR connection between the tuner outputs, where the desired tuner output is active and the undesired output is tri-stated (high impedance). However, other multiplexer arrangements may be employed.

In embodiments, each of tuner modules 206 and 208 may be implemented in separate physical packages (e.g., integrated circuits). Such separate packages may be arranged, for example, on a printed circuit board (PCB). For example, tuner modules 206 and 208 may be implemented in separate packages. However, these packages may be implemented on a single PCB. However, these separate packages may alternatively be on separate PCBs. For such implementations, signal isolation is defined by the physical package/PCB isolation between each tuner input port and output port.

Furthermore, implementations may completely isolate RF signal paths and tuner modules through techniques, such as Faraday caging. Thus with reference to FIG. 2, tuning modules 206 and 208 may be isolated from one another through such techniques.

Moreover, by performing selection among tuned signals, the leakage of RF signals is non-problematic. This is because such RF signals and tuned signals occupy different, non interfering parts of the RF spectrum.

Further advantages may be achieved through the approach of FIG. 2. For instance, such arrangements may consume significantly smaller volume than RF relay approaches. As an example, RF relay-based approaches can have a footprint area of 3-4 squared centimeters, whereas a silicon tuner may have a footprint of approximately one square centimeter

In addition, RF relay-based approaches can be approximately 1 centimeter in height. This may preclude such approaches from applications, such as notebook computers (for example in minicard form factors). However, the approach of FIG. 2 may achieve heights of less than 0.2 centimeters (i.e., the thickness of a typical surface mount package deployed for a silicon tuner).

Moreover, the approach of FIG. 2 may eliminate insertion losses associated with RF relays. As a result, a lower noise figure (NF) and an improved sensitivity may be attained. In addition, this approach may consume less power, as no standing power is needed to activate an RF relay.

Also, the approach of FIG. 2 allows an application-optimized tuner module to be employed for each signal source. In contrast, common tuner modules may compromise performance in one or all applications.

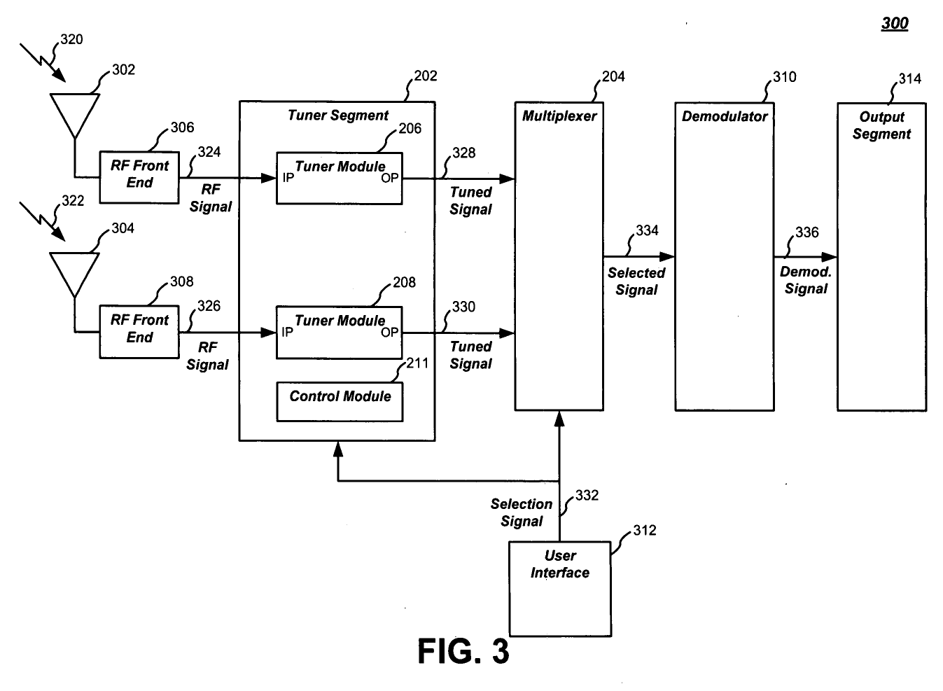

FIG. 3 is a diagram of an exemplary system 300. This system includes antennas 302 and 304, RF front ends 306 and 308, a demodulator 310, a user interface 312, and an output segment 314. In addition, system 300 includes apparatus 200 of FIG. 2. These elements may be implemented in hardware, software, or any combination thereof.

Antenna 302 receives a wireless signal 320 from a first remote source, and antenna 304 receives a wireless signal 322 from a second remote source. As an example, the first remote source may be a terrestrial broadcast tower, and the second remote source may be a cable. Embodiments, however, are not limited to these examples. Moreover, embodiments are not be limited to wireless signal reception. For instance, one or both of antennas 302 and 304 may be substituted with a wired (e.g., cable) interface that similarly receives RF signals.

As shown in FIG. 3, RF front end 306 is coupled to antenna 302, while RF front end 308 is coupled to antenna 304. RF front ends 306 and 308 may each include components, such as amplifier(s) (e.g., low noise amplifiers (LNAs)) and/or filter(s) to provide an input signal RF to a corresponding tuner module. In particular, FIG. 3 shows RF front end 306 providing an input RF signal 324 to tuner module 206, and RF front end 308 providing an input RF signal 326 to tuner module 208.

As described above with reference to FIG. 2, tuner modules 206 and 208 generate tuned signals from RF input signals 324 and 326, respectively. In particular, FIG. 3 shows tuner module 206 generating a tuned signal 328, and tuner module 208 generating a tuned signal 330.

As described above, implementations may completely isolate RF signal paths and tuner modules through techniques, such as Faraday caging. Thus with reference to FIG. 2, RF front end 306 and tuner module 206 may be isolated from RF front end 308 and tuner module 208. Such isolation may be implemented, for example, through Faraday caging techniques.

Based on a selection signal 332, multiplexer 204 forwards one of signals 328 and 330 to demodulator 310 as a selected signal 334. As described above, this selection may be based on a user input. Accordingly, FIG. 3 shows multiplexer 204 receiving selection signal 332 from user interface 312. User interface 312 may include one or more devices, such as buttons, keypads, touch screens, keyboards, and so forth. Additionally or alternatively, user interface 312 may include a handheld remote control device. Embodiments, however, are not limited to these examples.

Demodulator 310 receives and demodulates selected signal 334. This produces a demodulated signal 336. Such demodulation may be in accordance with various modulation techniques. Exemplary techniques include (but are not limited to) phase shift keying (PSK), quadrature phase shift keying (QPSK), asymmetric phase shift keying (APSK), quadrature amplitude modulation (QAM), and orthogonal frequency division multiplexing (OFDM). Additionally or alternatively, such demodulation may be in accordance with analog techniques such as frequency modulation (FM) and/or amplitude modulation (AM).

In embodiments, demodulated signal 336 may convey a video stream. More particularly, this stream may be a digital video stream (in encoded or unencoded format), or an analog video stream. Embodiments, however, are not limited to these examples, or to video applications.

As shown in FIG. 3, output segment 314 receives demodulated signal 336. From this signal, output segment 314 provides a user output, such as images and/or audio. Accordingly, output segment 314 may include devices, such as displays and/or audio speakers.

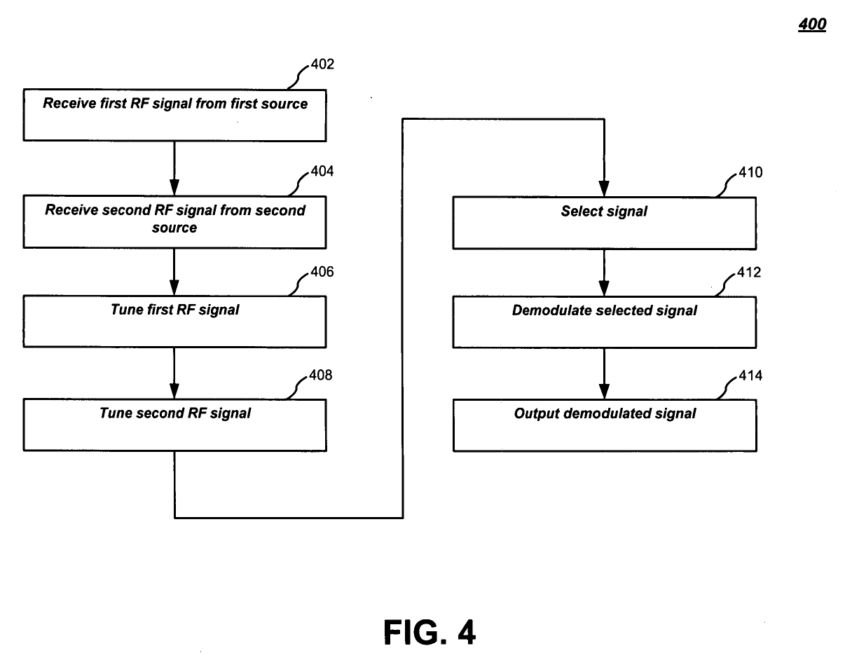

FIG. 4 illustrates an embodiment of a logic flow. In particular, FIG. 4 illustrates a logic flow 400, which may be representative of the operations executed by one or more embodiments described herein. Although FIG. 4 shows a particular sequence, other sequences may be employed. Also, the depicted operations may be performed in various parallel and/or sequential combinations.

At a block 402, a first RF signal is received from a first source. Similarly, at a block 404, a second RF signal is received from a second source. FIG. 4 shows that the first RF signal is tuned at a block 406, and the second RF signal is tuned at a block 408.

At a block 410, one of the first and second RF signals is selected. As described herein, selection of tuning signals (instead of RF signals) may advantageously overcome drawbacks associated with the employment of RF relays.

Further, as described above with reference to FIG. 3, the selected signal may be demodulated into a demodulated signal at a block 412. Additionally, this demodulated signal may be output to a user at a block 414. This output may be in the form of video and/or audio.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software.

The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

While various embodiments of the present invention have been described above, it should be understood that they have been presented by way of example only, and not in limitation. For example, the techniques described herein are not limited to video networks.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An apparatus, comprising:
a first tuner module to generate a first tuned signal from a first RF signal;
a second tuner module to generate a second tuned signal from a second RF signal; and
a multiplexer to select one of the first tuned signal and the second tuned signal based on a selection signal;
wherein the first RF signal corresponds to a first signal source, and the second RF signal corresponds to a second signal source.

2. The apparatus of claim 1:
wherein the first tuned signal is at a lower frequency than the first RF signal; and
wherein the second tuned signal is at a lower frequency than the second RF signal.

3. The apparatus of claim 1, further comprising a demodulation module to generate a demodulated signal from the selected signal.

4. The apparatus of claim 1, further comprising an output device to display an output based on the demodulated signal.

5. The apparatus of claim 1, further comprising a user interface to generate the selection signal based on a user selection.

6. The apparatus of claim 1, wherein the first RF signal is a video signal and the second RF signal is a video signal.

7. The apparatus of claim 1, further comprising:
a first antenna to receive the first RF signal, and
a second antenna to receive the second RF signal.

8. The apparatus of claim 1:
wherein the first tuner module is included in a first physical package, and the second tuner module is included in a second physical package; and
wherein the first and second physical packages are separate.

9. The apparatus of claim 8, wherein the first physical package comprises a first integrated circuit and the second physical package comprises a second integrated circuit.

10. The apparatus of claim 9, wherein the first and second integrated circuits are arranged on a printed circuit board.

11. The apparatus of claim 1, further comprising a control module to reduce operational power to the tuner module corresponding to the non-selected tuned signal.

12. The apparatus of claim 1, further comprising a control module to remove operational power to the tuner module corresponding to the non-selected tuned signal.

13. A method, comprising:
receiving a first RF signal from a first signal source;
receiving a second RF signal from a second signal source;
generating a first tuned signal from the first RF signal;
generating a second tuned signal from the second RF signal; and
selecting one of the first tuned signal and the second tuned signal.

14. The method of claim 13, further comprising:
demodulating the selected signal.

15. The method of claim 14, wherein said demodulating comprises demodulating in accordance with an orthogonal frequency division multiplexing (OFDM) technique.

16. The method of claim 14, further comprising:
displaying an output based on the demodulated signal.

17. The method of claim 13:
wherein the first tuned signal is at a lower frequency than the first RF signal; and
wherein the second tuned signal is at a lower frequency than the second RF signal.

18. The method of claim 13:
wherein the first RF signal is a video signal; and
wherein the second RF signal is a video signal.

19. The method of claim 11, further comprising reducing operational power to a tuner module, the tuner module corresponding to the non-selected tuned signal.

20. The method of claim 11, further comprising removing operational power to a tuner module, the tuner module corresponding to the non-selected tuned signal.
